(19) United States
(12) Patent Application Publication
(10) Pub. No.: US 2015/0067399 A1
(43) Pub. Date: Mar. 5, 2015

(54) ANALYSIS, RECOVERY AND REPAIR OF DEVICES ATTACHED TO REMOTE COMPUTING SYSTEMS

(71) Applicant: Jon Jaroker, New York, NY (US)

(72) Inventor: Jon Jaroker, New York, NY (US)

(21) Appl. No.: 14/012,751

(22) Filed: Aug. 28, 2013

(51) Int. Cl. G06F 11/34

(52) U.S. Cl. CPC G06F 11/3409
USPC 714/37

(57) ABSTRACT

A method and system to perform analysis, recovery or repair of devices attached to a remote computing system from a local computing system is presented. The remote computing system is initialized with an independent operating system that executes computer code, and interfaced, over a digital network, with a local computing system. This converts the remote computing system into an analysis, recovery and repair tool for the remote delivery of advanced technical services such as: network analysis, data recovery, digital forensics, software installation and operating system repair, data cloning, and malware remediation.

### CROSS-REFERENCE TO RELATED APPLICATION

Some of the subject matter disclosed in this application relates to the subject matter in U.S. patent, “System and method for deploying and maintaining software applications”, U.S. Pat. No. 8,346,897 (“U.S. Pat. No. 8,346,897”) which is hereby incorporated by reference in its entirety.

This application claims the benefit of Provisional Patent Applications Nos. 61/733,621 (filed 5 Dec. 2012) and 61/860,300 (filed 31 Jul. 2013), both entitled “Analysis, Recovery and Repair of Devices Attached to Remote Computing Systems,” the entireties of which are incorporated herein by reference.

### FIELD

The present invention relates to systems and methods for access to remote computing systems, more particularly to achieving low-level access to devices attached to a remote computing system for the purposes of delivering analysis, recovery, or repair services over a digital network. In one embodiment, the remote computing system's hardware is utilized as a remote analysis, repair and recovery platform without the installation of software to, or modification of data on, non-volatile storage devices attached to the remote computing system. This recovery platform is controlled remotely by a technical support expert or script in order to deliver support services. Other embodiments are also described.

### BACKGROUND

U.S. Pat. No. 8,346,897 describes the limitations of traditional remote access methods that depend upon a suitable native operating system pre-installed on a remote computer. In critical, real-world situations such as data toss or instability, this native operating system cannot be retied upon (or should not be used) for the purposes of delivering remote technical support.

### SUMMARY

The embodiment described in this invention further extends the methods and systems of U.S. Pat. No. 8,346,897 to situations were special-purpose computing devices such as consumer electronics (like smartphones), peripherals (like printers), or components (like hard disk drives) are themselves analyzed, recovered or repaired remotely over a digital network. Troubleshooting or repairing these types of devices currently requires physical access to the device. This requirement is an inconvenience and expense for the user and sales limitation for the technical support provider.

In the current invention, the user always retains physical ownership of the device to be analyzed, recovered or repaired, eliminating travel or shipping costs, delays and inconveniences. This makes service delivery less expensive, faster and simpler for the user. The technical support expert also benefits by expanding the geographic area that can now be serviced. In one embodiment described below, the device to be analyzed, recovered or repaired will be virtually connected to the expert's local workstation, allowing him to use his existing tools to deliver the support services. This increases revenue potential for the expert and support organizations.

In one embodiment of the present invention, a computing system is converted into an analysis, recovery and repair tool for the remote delivery of advanced technical services. Some aspects include:

(a) initializing a remote computing system with a special-purpose, independent operating system by any user who has physical access to the remote computing system;

(b) preserving data on non-volatile storage devices from inadvertent modification;

(c) executing program code, in conjunction with the independent operating system, that converts the remote computing system into an analysis, recovery or repair tool;

(d) establishing a secure communication link between the remote computing system and a local computing system operated by a technical expert;

(e) enabling access to devices attached to the remote computing system; and,

(f) allowing advanced technical services to be performed on the remote computing system or devices attached to the remote computing system from the local computing system.

Additional features, such as the design of the independent operating system and access to low-level components on physical devices, will become apparent from a consideration of the ensuing description and drawings. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 is a block diagram showing an example environment where an embodiment of the present invention can be implemented;

FIG. 2 is a block diagram showing an independent operating system loaded from a storage media to a remote computing system;

FIG. 3 is a block diagram showing an independent operating system downloaded from a computer server over a digital network to a remote computing system;

FIG. 4 is a block diagram showing an independent operating system loaded from a mobile computing device to a remote computing system, where the independent operating system is acquired from an online marketplace for mobile applications;

FIG. 5 is a block diagram showing program code on a remote computing system and a client application on a local computing system interfacing through an application programming interface provided by the program code;

FIG. 6 is a block diagram showing program code on a remote computing system and a client application on a local computing system interfacing through a queue server that exchanges messages and commands;

FIG. 7 is a block diagram showing access to a remote storage device from a local computing system using iSCSI techniques in one embodiment of the present invention;

FIG. 8 is a block diagram showing the virtualization process;

FIG. 9 is an activity diagram illustrating the operation of the system;

FIG. 10 is a block diagram illustrating a joined file system; and

FIG. 11 is a block diagram showing another embodiment of the joined file system.

### DETAILED DESCRIPTION OF PREFERRED EMBODIMENT

The present invention may be further understood with reference to the following description and the appended drawings, wherein like elements are labeled with the same reference numerals.

### Overview

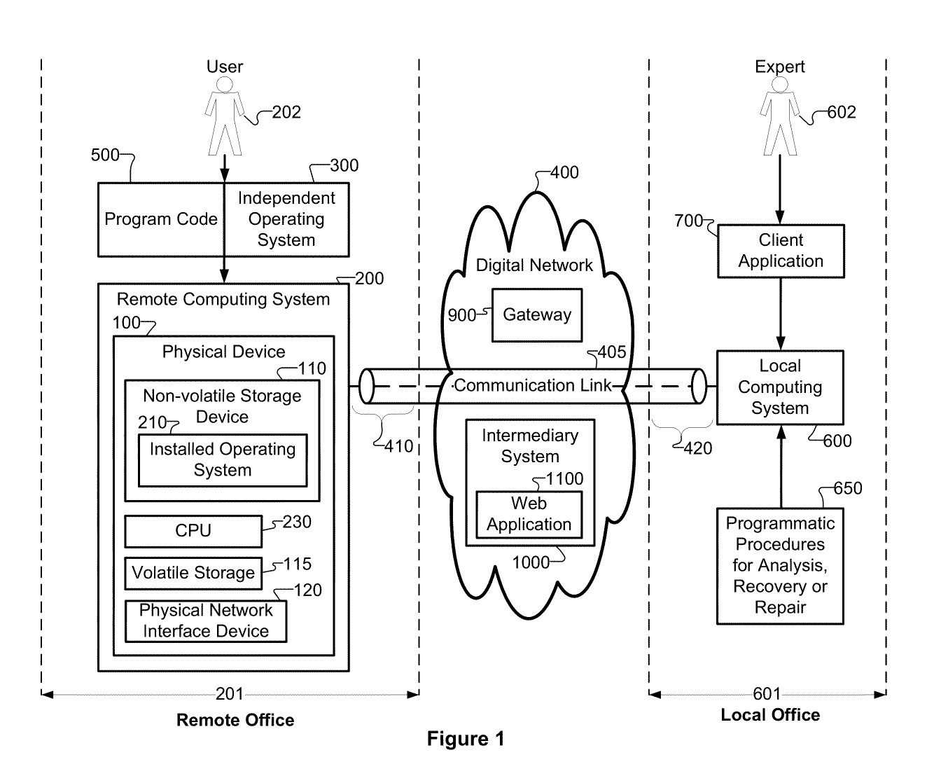

FIG. 1 shows a preferred embodiment of the present invention. A Remote Computing System 200 in a Remote Office 201 under the control of User 202 receives manual support services performed by a technical Expert 602 or automated analysis, recovery or repair services delivered through Programmatic Procedures 650.

Program Code 500, in collaboration with the Independent Operating System 300, temporarily converts the Remote Computing System 200 into an analysis, recovery and repair tool that provides low-level access to an attached Physical Device 100. During this conversion, the Installed Operating System 210 previously installed on the Remote Computing System 200 is in abeyance while the Independent Operating System 300 is running on the Remote Computing System 200.

The Physical Device 100 may be a consumer electronic device such as a tablet computer, digital camera or smartphone that is connected to the Remote Computing System 200 by a data link such as Firewire, Universal Serial Bus (USB), Category 5 cable (Cat5), WiFi, Bluetooth or anything similar as long as the Physical Device 100 is accessible from the Remote Computing System 200.

The Physical Device 100 may also be a component of the Remote Computing System 200, such as Non-volatile Storage Device 110 or Physical Network Interface Device 120.

The Program Code 500 establishes a secure Communication Link 405 between the Remote Computing System 200 in a Remote Office 201 and a Local Computing System 600 in a Local Office 601. The Communication Link 405 traverses a Digital Network 400 which can contain Gateway 900 devices as well as various Intermediary Systems 1000. The Gateway 900 and intermediary Systems 1000 serve to support the communication and service delivery between the Remote Computing System 200 and Local Computing System 600. For example, Gateway 900 may be used for firewall traversal and Intermediary System 1000 may be used for recording of the support session.

A graphical interface is provided to the Expert 602 through a Client Application 700 that runs on the Local Computing System 600. The Client Application 700, in conjunction with the Program Code 500 and various Intermediary Systems 1000, allows the Expert 602 to deliver advanced technical support services remotely.

### Independent Operating System and Program Code

The Independent Operating System 300 and Program Code 500 of FIG. 1 are used to temporarily convert the Remote Computing System 200 into a specialized access, analysis, recovery and repair platform. This temporary conversion may last for the duration when the Independent Operating System 300 is operating on the Remote Computing System 200. During this time, the independent Operating System 300 allows low-level access to Physical Devices 100 attached to the Remote Computing System 200; for example, raw read or write data access to a Non-volatile Storage Device 110 such as a hard disk drive.

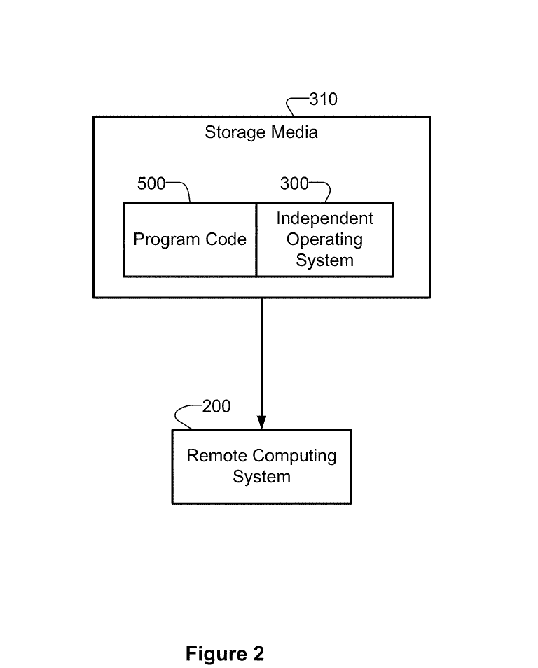

In the current preferred embodiment of the present invention, the Independent Operating System 300 uses a customized Debian distribution and is delivered via a bootable Storage Media 310 as shown in FIG. 2. The desirable customizations include:

(a) a “toram” boot option parameter that prevents the Independent Operating System 300 from modifying the temporary data areas of Non-volatile Storage Device 110 on the Remote Computing System 200 during the initialization process;

(b) a unified file system—such as the UnionFS open source project—that virtually joins the directory structure existing on the Storage Media 310 with the directory structure created in Volatile Storage 115 of the Remote Computing System 200;

(c) removal of unnecessary software, such as graphics intensive applications, from the Independent Operating System 300; and,

(d) re-compilation of the Linux kernel to include header files and modules required to enable low-level device access and device virtualization.

Program Code 500 extends the Independent Operating System 300 to provide additional software applications used by technical Experts for delivery of repair Or recovery services. Typically, the Program Code 500 is a combination of kernel-compiled and separate packages. Program Code 500 includes software such as:

(a) special headers required for virtualization applications, such as VirtualBox headers;

(b) drivers such as for NTFS file system support and RAID devices; and,

(c) packages that are executed after the Independent Operating System 300 initializes the Remote Computing System 200, such as hardware analysis utilities and data recovery applications.

As an example: To achieve low-level access to non-volatile storage devices, the Independent Operating System 300 and Program Code 500 are configured with drivers or kernel patches necessary to enable technologies such as Internet SCSI (iSCSI), Fibre Channel over IP (FCIP), Internet Fibre Channel Protocol (iFCP) or any other future technology for networked access to storage devices. This specific example will describe the iSCSI implementation; but those skilled in the art will understand that other implementations can be achieved in a similar manner.

In the case of iSCSI computer code, a modern Linux kernel may already include an iSCSI target driver or code. Improved performance or stability may require the addition of patches and re-compilation of the kernel. In the current preferred embodiment, “Generic SCSI Target Subsystem for Linux” source code is used and improved performance is achieved by adding kernel patches “put_page_callback” and “scst_exec_req_fifo”.

The Independent Operating System 300 provides a platform on which the Program Code 500 executes. Some Program Code 500 functionality makes use of the Independent Operating System 300, such as when establishing the Communication Link 405. While the Program Code 500 will establish the Communication Link 405, those skilled in the art will realize that the Independent Operating System 300 must first initialize the network interface controller and obtain an IP address before any further communication can proceed.

The Independent Operating System 300 will be based on different software distributions depending on the Remote Computing System's 200 hardware. For example, Intel and ARM based CPUs will require different operating system and device driver versions.

### Digital Network and Communication Link

With reference to FIG. 1, a Communication Link 405 between the Remote Computing System 200 and the Local Computing System 600 is established through a Digital Network 400. The Communication Link 405 provides a secure way to exchange commands and data between these two systems 200 and 600. The Communication Link 405 may traverse Gateway 900 systems and Intermediary Systems 1000 that provide firewall traversal, message queue, monitoring, accounting, and other supporting services useful in creating a robust and resilient means to exchange commands and data between these two systems. Interfacing between a Client Application 700 operating on the Local Computing System 600 and the Program Code 500 executing on the Remote Computing System 200 occurs through the Communication Link 405,

The Digital Network 400 shown in Figure it may include local and public network segments. Those skilled in the art will recognize this as a typical computer network topology including local area networks 410 and 420 located in the Remote Office 201 and Local Office 601, respectively.

To facilitate security, network routing and address traversal, Gateway 900 systems may be used to connect local networks 410 and 420 with a public data network. Typical Gateway 900 systems include firewalls, routers and switches.

Encryption may be provided by Gateway 900 systems or as part of the functionality of the Program Code 500. In the latter case, SSL encryption may be established through the use of an SSH tunnel where the SSH server software is one of the Program Code 500 applications operating on the Remote Computing System 200.

An Intermediary System 1000 may be used to establish a Communication Link 405. An example of this approach and system is the “Border Controller” described in U.S. Pat. No. 8,346,897.

The local area networks 410 and 420 of FIG. 1 may include wired and/or wireless data links. The wireless links may be created through data or cellular radios. For example, a mobile telephone device can provide the wireless local area network 410 connection to the Digital Network 400 through either a wireless or tethered connection between the mobile telephone device and the Remote Computing System 200. This type of connection is useful in field repair situations, where the Remote Computing System 200 cannot be connected to a traditional wired network.

### Remote Computing System

The Remote Computing System 200 shown in FIG. 1 may be any computing device that contains, at minimum, (i) a Central Processing Unit (CPU) 230 or other controlling logic, (ii) Volatile Storage 115 to hold data and runtime programs, (iii) a Physical Network interface Device 120, and (iv) an ability to load and run program code, such as its Installed Operating System 210. Those skilled in the art will recognize these common components as describing any type of computing system. For example, the Remote Computing System 200 may be a standard computer such as a laptop computer, desktop computer, workstation, or server.

The methods described by this invention can be applied to generalized computing devices beyond the traditional laptop or PC. Examples of generalized Remote Computing System 200 include mobile devices (such as a phone, smartphone, tablet computer, or mobile digital reader) and appliances (such as a telephone switching device, networked storage server, email or security system, or a network router, gateway or switch).

### Physical Devices

The Physical Device 100 attached to or a component of the Remote Computing System 200 is the device to be analyzed, recovered or repaired. Examples of Physical Devices 100 include internal and external hard disk drives, storage controllers, interface cards, memory, or other peripherals or components of a computing system. The Physical Device 100 may be attached to the Remote Computing System 200 through either a wired or wireless data connection.

Wired connections include USB and Firewire cables as well as internal cabling or circuit board trace wires when the Physical Device 100 is a component of the main circuit board of the Remote Computing System 200.

Wireless connections include connection methods such as Wireless Display (WiDi), WiFi, Bluetooth and Wireless USB. In such situations, the Physical Device 100 can be considered a wireless peripheral of the Remote Computing System 200. Examples of wireless attached Physical Devices 100 include WiDi-connected televisions, WiFi-connected printers, Bluetooth-connected speakers and Wireless USB-connected game controllers.

### Virtualization

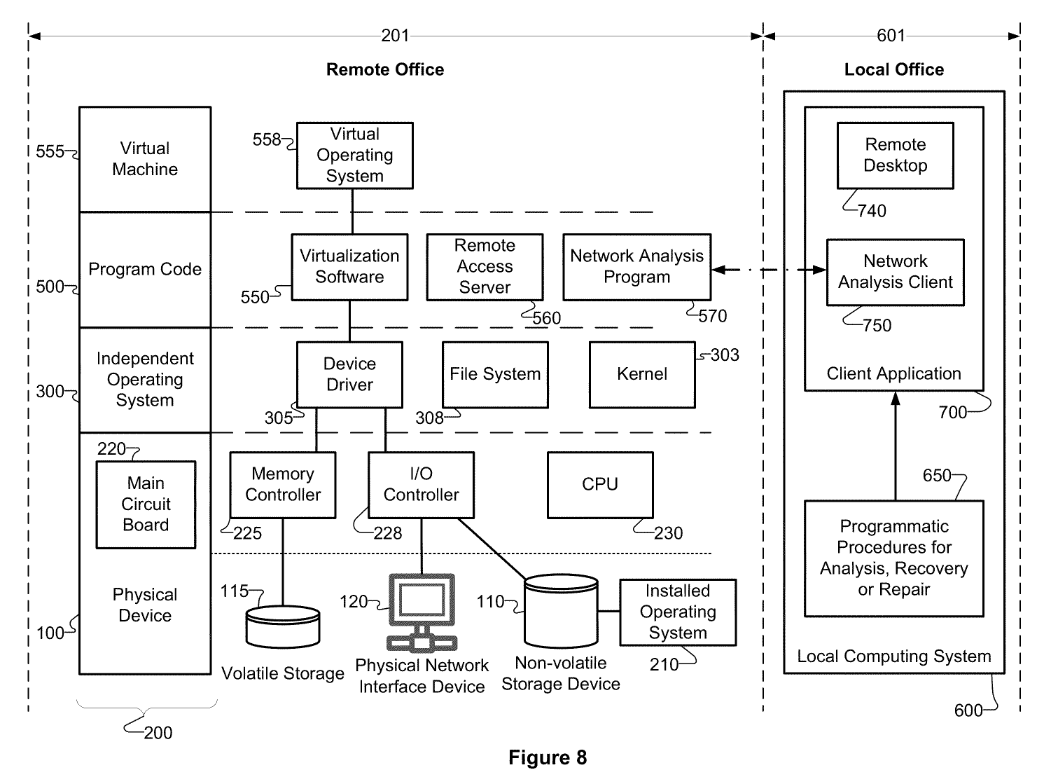

Virtualization technology, implemented through Program Code 500 in conjunction with the Independent Operating System 300, allows special diagnostic and repair procedures to be employed on the Remote Computing System 200. With reference to FIG. 8, Virtualization Software 550 running on the Remote Computing System 200 is used to create a Virtual Machine 555 that allows either:

(I) the execution of a Virtual Operating System 558 that is independent of the Installed Operating System 210; or,

(II) the execution of the Installed Operating System 210 as the Virtual Operating System 558.

### Virtualization Case I

The first case describes the creation of a standard virtual environment. It is useful for remote analysis, repair, and recovery because it allows special purpose software utilities to be executed using their prerequisite operating system (such as Microsoft DOS) on different host operating systems installed on the Remote Computing System 200. This permits legacy software applications to be executed on diverse hosts and accessed remotely.

To implement the first case on the Remote Computing System 200, the system configuration includes:

(a) Initializing the Remote Computing System 200 with the Independent Operating System 300 and Program Code 500. Software for creating Virtual Machines 555 along with a guest operating system (or provisions for downloading it from a networked server), is included in the Program Code 500.

(b) Creating a Virtual Machine 555 executing the Virtual Operating System 558;

(c) Accessing the Virtual Machine 555 via the Remote Computing System 200. The Program Code 500 provides a Remote Access Server 560 that allows a Remote Desktop 740 connection from the Local Computing System 600; and,

(d) Executing diagnostic, repair or recovery utilities that are either natively installed on the Virtual Operating System 558 or downloaded from an external location.

The Remote Computing System 200 has now been converted into a recovery platform, allowing manual and automated delivery of technical support services.

### Virtualization Case II

The second case describes a configuration to virtualize the Remote Computing System 200 using the Remote Computing System 200 itself as the virtualization host. In this second case, the Program Code 500 creates a Virtual Machine 555 which emulates the original hardware of the Remote Computing System 200. The Installed Operating System 210, which may be unstable, is then used to boot this Virtual Machine 555.

Virtualizing the Remote Computing System into a Virtual Machine creates a virtual testing environment where the Remote Computing System may be tested and analyzed. With reference to FIG. 1, this useful configuration is achieved as follows:

(a) Virtualization Software 550 emulates the CPU 230, I/O Controller 228, Memory Controller 225, Non-volatile Storage Devices 110, Physical Network Interface Devices 120, Volatile Storage 115, and other major components of the Main Circuit Board 220. This emulation is required for normal execution of the Installed Operating System 210, such as passing authenticity checks. Other Physical Devices 100 are also emulated by the Virtualization Software 550. This emulation is achieved using device drivers that are common to existing virtualization technologies such as VirtualBox, Xen, VMWare and Qemu.

Virtualization Software 550 uses the Installed Operating System 210 of the Remote Computing System 200 as the basis for the Virtual Operating System 558. There are standard procedures to achieve this, namely the mounting of an existing disk partition into a File System 308 that is used to initialize the Virtual Machine 555.

(c) Supporting Virtual Machines 555 are created for network routing and analysis. These Supporting Virtual Machines 555 intercept data packets from the Virtual Machine running the Installed Operating System 210 of the now-virtualized Remote Computing System 200. Network protocol and traffic analyzers—such as the open source “Wireshark” and “SNORT” software—are run in the Supporting Virtual Machine 555. An alternative to creating these virtual machines 555 is to execute the network routing and analysis software directly on the host computer, e.g. the Remote Computing System 200. This alternative approach creates a virtual testing environment with the same analysis, recovery, and repair capabilities.

(d) Remote Desktop 740 connections from the Local Computing System 600 are used to interact with the now-virtualized Installed Operating System 210 and resulting network traffic is captured and analyzed. This may be achieved in an automated way, using Programmatic Procedures 650, or a manual approach using a Client Application 700.

(e) To aid in the analysis, a Network Analysis Client 750 may be used to display data and charts on the Local Computing System 600 using the raw data produced by the Network Analysis Program 570. In the example shown in FIG. 8, the Network Analysis Program 570 is executing on the Remote Computing System 200.

In this manner, the Remote Computing System 200 can be quarantined into a Virtual Machine 555 for testing and low-level analysis from a remote location. Remote access may be established using the Remote Desktop 740 client.

A further refinement to the virtualization of the Remote Computing System 200 is described below. This refinement explains how the Installed Operating System 210 can be restricted to read-only mode while still allowing a Virtual Machine 555 to use it as the basis of the Virtual Operating System 558.

### Joined File System

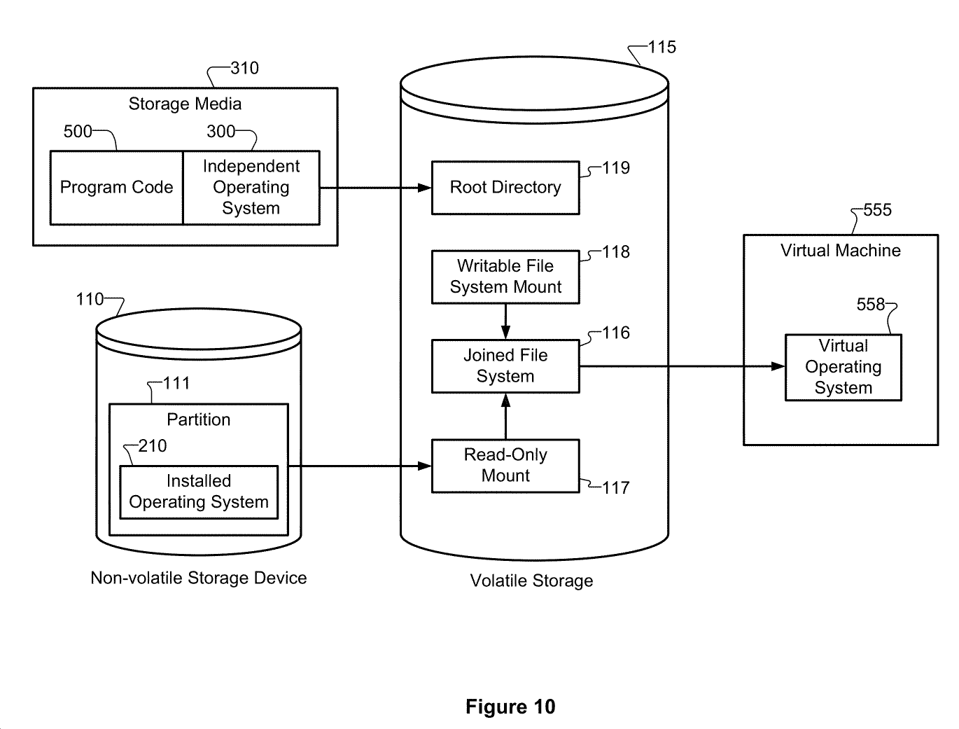

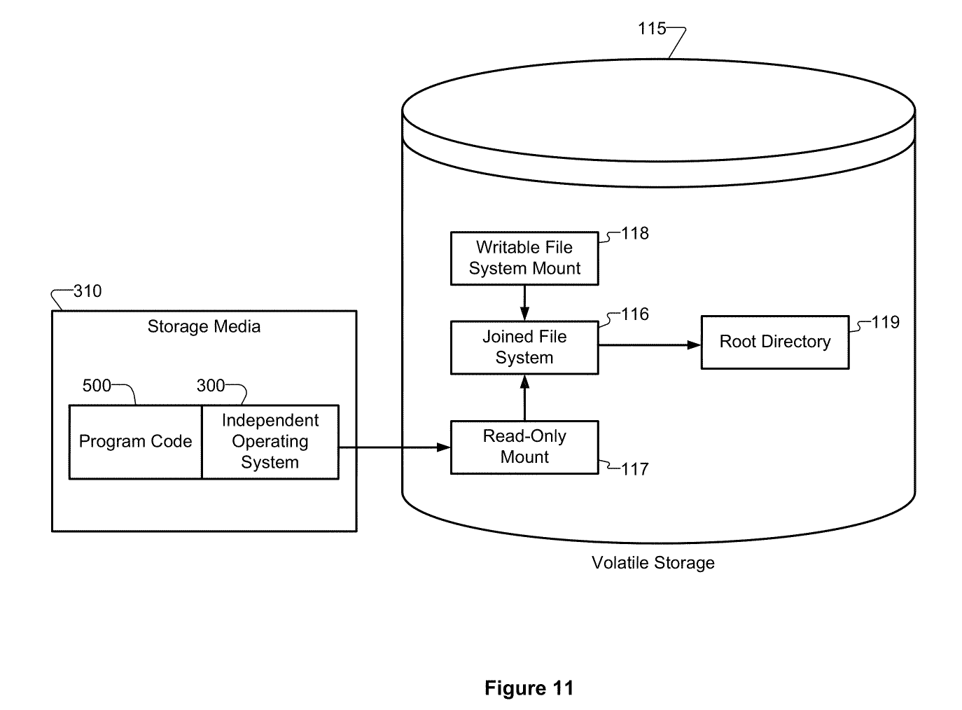

A Joined File System permits read and write access to a read-only file system. This read-only file system may be either the Independent Operating System 300, as shown in FIG. 11, or the Installed Operating System, as shown in FIG. 10. In both cases, a Writable File System Mount 118 is overlayed on the Read-Only Mount 117 to create the Joined File System 116. Those skilled in the art will recognize the Joined File System 116 as a special and unique application of namespace unifying file systems such as “Plan 9” and “UnionFS”.

FIG. 10 shows one embodiment of a Joined File System 116. In this example, the Volatile Storage 115 (e.g. RAM) is used to simulate traditional file systems such as (i) the Partition 111 holding the Installed Operating System 210, and (ii) the Writable File System Mount 118. While Partition 111 is mounted as a Read-Only Mount 117, the Writable File System Mount 118 is capable of storing data.

With reference to FIG. 10, when Partition 111 is mounted in read-only mode, the Joined File System 116 will allow installation of computer programs to a Virtual Machine 555 running the Installed Operating System 210 without modifying the data on Partition 111 containing that Installed Operating System 210. This useful capability enables Experts to deliver data recovery and forensics services using the Remote Computing System 200 as the recovery platform while preserving the underlying data to be recovered or analyzed.

These two mountings (Read-Only Mount 118 and Writable File System Mount 118) are joined by the file system into the Joined File System 116. This Joined File System 116 is used as the basis for the Virtual Operating System 558 of the Virtual Machine 555.

The data for the Virtual Operating System 558 is the original data stored on Partition 111, meaning that the Virtual Operating System 558 will initially be executed in exactly the same manner as if the Installed Operating System 210 were being booted. However after initialization of the Virtual Machine 555, all data modifications will actually be stored in the Writable File System Mount 118. The original data in Partition 111 remains unchanged.

Virtual Machine 555 can be operated normally, such as modifying data and installing new software programs without disturbing the Installed Operating System 210. These modifications do not persist after the Remote Computing System 200 is rebooted and a new Joined File System 116 is created.

This useful innovation allows temporary changes to be made to a Remote Computing System 200, such as for testing compatibility of new device drivers or investigating suspicious software behavior. The “Enabling a Joined File System” section below provides more information on how to set up the Joined File System 116.

FIG. 11 shows another embodiment of the Joined File System 116. In this embodiment, the operating system delivered as the Independent Operating System 300 is used for the Read-Only Mount 117. This approach allows the Independent Operating System to be delivered on a read-only media, such as DVD or CDROM, but still appear as a writable file system.

### Intermediary System

With reference to FIG. 1, the Intermediary System 1000 is a network-resident server that runs a Web Application 1100. These Intermediary Systems 1000 are fully described in U.S. Pat. No. 8,346,897 and that description is fully incorporated by reference herein. The Intermediary Systems 1000 are used in the current invention to support service delivery, such as:

(1) Integrating server-side applications with the Client Application 700. This integration allows user-data storage and retrieval, web application interface display and web application controls. When used for delivery of Web Application 1100, the Client Application 700 could be as simple as a standard web browser.

(2) Establishing and securing the Communication Link 405, such as using the border controller system described in U.S. Pat. No. 8,346,897.

(3) Authenticating User 202 and Expert 602 through a login system that checks provided credentials against those stored in a central database.

(4) Identifying User 202 or Expert 602 and granting access and control privileges based on user type, role, and permissions.

(5) Monitoring and calculating time spent, resources consumed, and credit and debit balances through means of an accounting system.

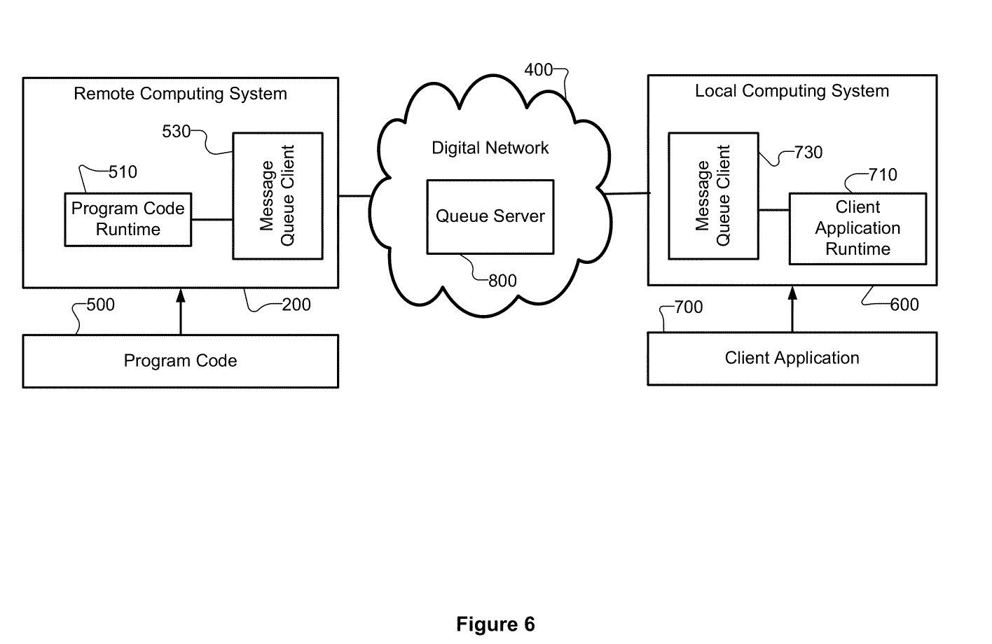

With reference to FIG. 6, the Intermediary System 1000 can also be a Queue Server 800 that exchanges messages between the Local Computing System 600 and the Remote Computing System 200. Messages and data may be produced and consumed using Message Queue Clients 530 and 730 on the Remote Computing System 200 and Local Computing System 600, respectively. These clients 530 and 730 integrate with the Program Code Runtime 510 and Client Application Runtime 710 on their respective systems 200 and 600. Those skilled in the art will recognize the Queue Server 800 may be such systems as Apache's ActiveMQ.

### Client Application

With reference to FIG. 1, the Local Computing System 600 may be used by the Expert 602 to deliver remote technical support services using the Client Applications 700. Examples of Client Applications 700 include:

(a) Third-party software such as Microsoft and VNC remote desktop applications;

(b) Terminal emulators such as provided by Telnet and SSH software clients;

(c) Web browsers that access network-based Web Applications 1100; and,

(d) Client-server applications where the client portion runs on the Local Computing System 600 and interfaces with a server portion executing as Program Code 500 on the Remote Computing System 200.

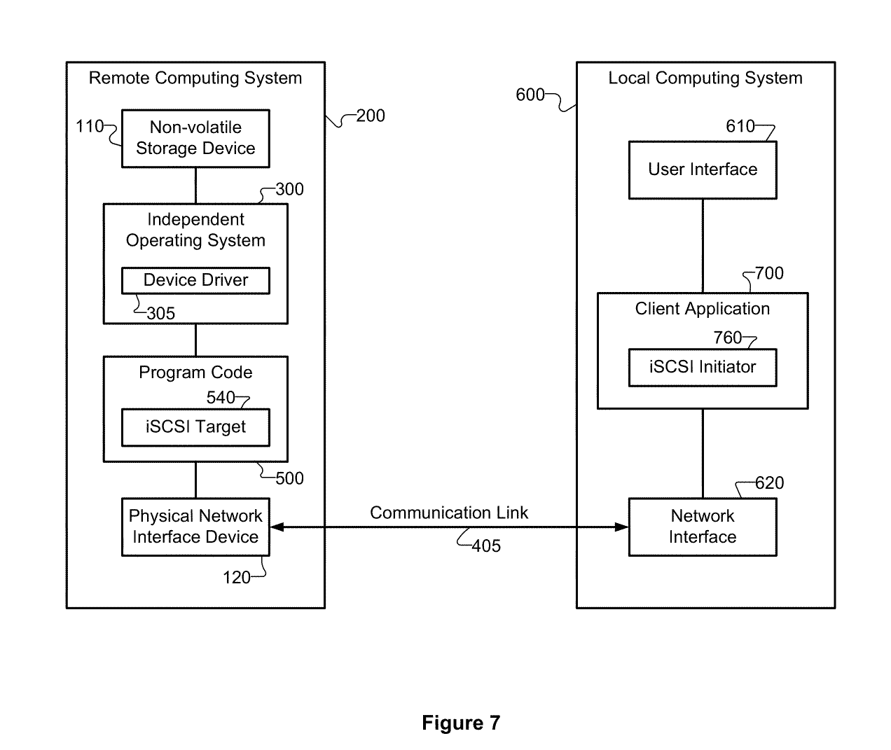

The client-server applications mentioned above can be further illustrated with reference to FIG. 7, which shows one embodiment of remote hard disk mounting. In this embodiment, iSCSI Target 540 server code operates on the Remote Computing System 200 as part of Program Code 500. The iSCSI Target 540 server code provides an interface to Non-volatile Storage Devices 110. This interface offers low-level control of, and raw data access to, Non-volatile Storage Devices 110 and satisfies the previously mentioned restrictions for data recovery and forensics procedures.

iSCSI technology provides a way for the Non-volatile Storage Device 110 to be virtually mounted to the Local Computing System 600. This remote mounting uses the iSCSI Initiator 760 software as the Client Application 700 running on the Local Computing System 600. This Client Application 700 allows the Expert 602 to use the specialized User Interface 610 of an analysis, recovery, or repair software application that is running on the Local Computing System 600 but acting upon the remote Non-volatile Storage Device 110.

### Initializing the Remote Computing System

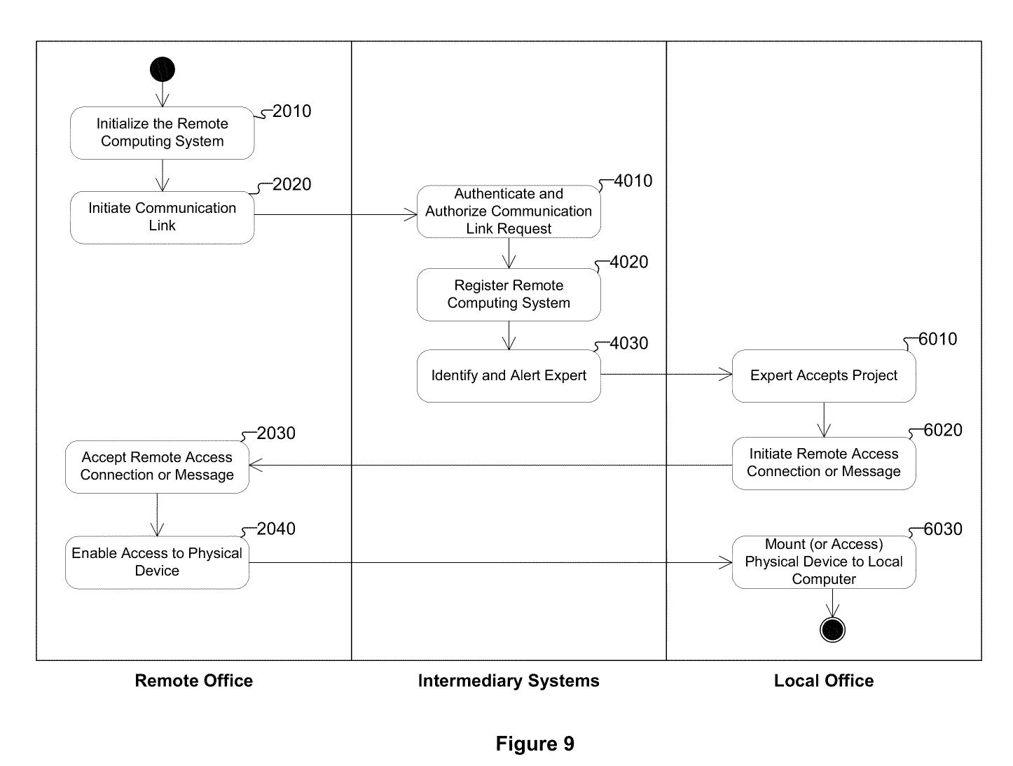

The technical support delivery process begins when a User 202 initializes the Remote Computing System 200 with the Independent Operating System 300 and Program Code 500, as illustrated in FIG. 1. The Independent Operating System 300 can be delivered to the Remote Computing System 200 in one of several different techniques, as described here. These different techniques are examples of initialization means and are shown as initial Step 2010 in FIG. 9.

With reference to FIGS. 2-4, the Remote Computing System 200 can be initialized through such methods as a Storage Media 310, Mobile Computing Device 330, or a download from a Computer Server 320. Those skilled in the art will recognize that different methods can be used to deliver the Independent Operating System 300 and the Program Code 500. For example, the Storage Media 310 can be used to deliver the Independent Operating System 300 while the Computer Server 320 can be used to deliver the Program Code 500. As a simplification, the following discussion will assume that the Independent Operating System 300 and the Program Code 500 are delivered using the same method.

FIG. 2 shows initialization occurring via a Storage Media 310, which can be a CDRom, DVD disc, or flash drive. This type of initialization is common when the Remote Computing System 200 is a standard computer with facilities to boot from such media. The process involves physically connecting the Storage Media 310 to the Remote Computing System 200 and then restarting System 200.

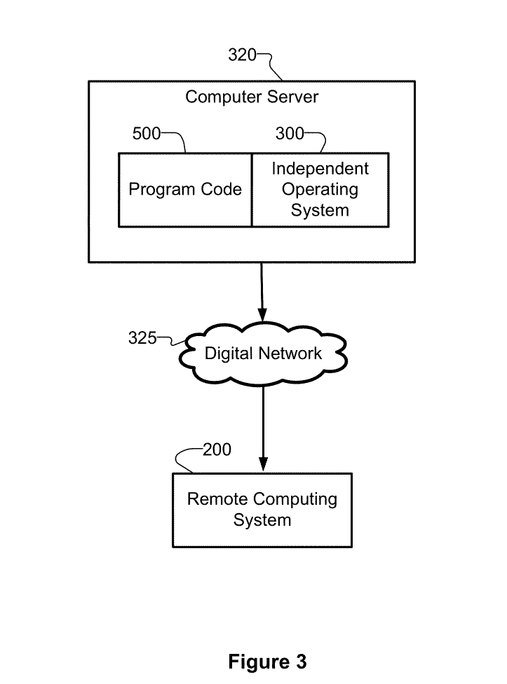

Network booting is an initialization method that can be used with non-standard computing devices such as telephone handsets, phone systems, network cameras, and so on. In reference to FIG. 3, the Remote Computing System 200 uses a Digital Network 325 to obtain the Independent Operating System 300 and Program Code 500 from a Computer Server 320 that is configured to support this type of delivery. For example, the Computer Server 320 could be configured as a Trivial File Transfer Protocol (TFTP) server.

This type of network booting approach eliminates the need for a physical Storage Media 310 and device to read from such media. Instead, the Remote Computing System 200 now requires only a connection to a Digital Network 325, where such a connection can be a physical wire or a wireless radio link, and the ability to boot from the downloaded files. In this specific example, the Remote Computing System 200 would employ a PXE Booting process, a known process to those skilled in the art.

The Digital Network 325 of FIG. 3 can be either independent from or a subset of the Digital Network 400 of FIG. 1. For example, the Remote Computing System 200 can have two network interface connections: one to a local network where Computer Server 320 resides and another to a public network where the Intermediary Systems 1000 reside. Alternatively, the Computer Server 320 could be a type of Intermediary System 1000 and resides within the greater Digital Network 400 depicted in FIG. 1. These are two examples of common network topologies illustrating how booting can occur over a local or public network. As those skilled in the art will recognize, other topologies are possible.

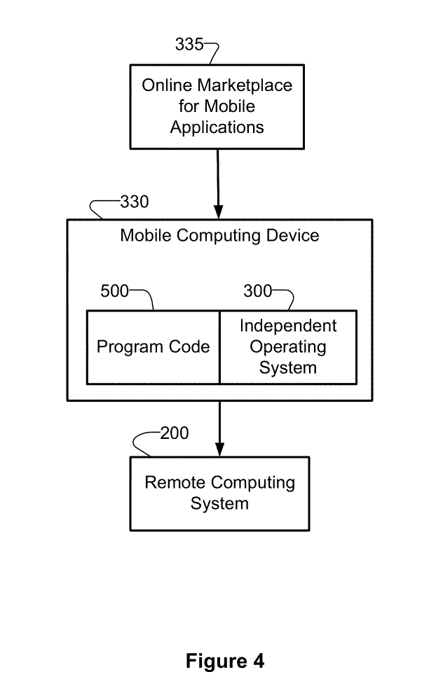

Another method to initialize the Remote Computing System 200 involves a Mobile Computing Device 330, as shown in FIG. 4. The Mobile Computing Device 330 could be a tablet computer, mobile phone or some other lightweight device capable of delivering digital files. The connection between the Mobile Computing Device 330 and the Remote Computing System 200 could be wired, such as a USB cable connection, or wireless, such as WiFi or Bluetooth connection.

To achieve this initialization, the Mobile Computing Device 330 is configured as a “host system”. For example, if the connection is through a USB connection then the Mobile Computing Device 330 would need to be configured as a USB host and recognizable as a bootable device by the Remote Computing System 200. Those skilled in the art will be familiar with the standard procedures required to configure a Mobile Computing Device 330 into a bootable host system.

The Mobile Computing Device 330 that is configured as a “host system” can have the same functionality as the Computer Server 320 from FIG. 3. Namely, the Mobile Computing Device 330 is configured as a file server that delivers the Independent Operating System 300 and Program Code 500 as digital files to the Remote Computing System 200 in a similar manner to that described for the Computer Server 320 above.

The Mobile Computing Device 330 will most likely include an independent wireless data connection that can be used to download files, such as from the Online Marketplace for Mobile Applications 335 depicted in FIG. 4. Such an online marketplace can be the source for the Independent Operating System 300 and Program Code 500 files. The User 202 acquires and downloads these files to the Mobile Computing Device 330 from the Online Marketplace for Mobile Applications 335. Obtaining the Independent Operating System 300 and Program Code 500 files in this manner would be simpler and faster than the two alternative methods described above. Once these are obtained, the User 202 connects the Mobile Computing Device 330 to the Remote Computing System 200 to begin the initialization process.

### Establishing Communication and Remote Access

Program Code 500, in conjunction with the Independent Operating System 300, initiates the Communication Link 405 between the Remote Computing System 200 and a Local Computing System 600 as depicted in FIG. 1 and shown as Step 2020 in FIG. 9. As fully described in U.S. Pat. No. 8,346,897 and incorporated by reference herein, in one embodiment the Program Code 500 may contain network addresses and keys used in public-key cryptography. In this embodiment, a software agent within the Program Code 500 attempts to connect to either Gateway 900 or Local Computing System 600 using an ssh connection and gateway port forwarding. The ssh tunnel created in this manner becomes the Communication Link 405 shown in FIG. 1.

The Gateway 900 system receives the Communication Link request and Intermediary Systems 1000 authenticates and authorizes this request, as shown at Step 4010 in FIG. 9. As part of the Initiate Communication Link Step 2020, the User may either input login credentials or these credentials may be stored as part of the Program Code 500.

The Remote Computing System 200 is then registered with the Intermediary Systems 1000 in Step 4020. Registration includes the authentication of login credentials and identifying the User's 202 roles and permissions.

Business logic, implemented on a Web Application 1100 running on an Intermediary System 1000, determines which Expert 602, or set of Experts 602, receives a notification that a Remote Computing System 200 is requesting technical support services, as shown in Step 4030. An Expert 602, or a team of Experts 602, then accepts the technical support project, as indicated by Step 6010. The Expert 602 uses the Client Application 700, which could be a web browser, to receive this alert and accept the project.

Using Client Application 700—which could be a web browser, remote desktop client software, or SSH client—the Expert 602 initiates a connection to the Remote Computing System 200, as shown in Step 6020. In its simplest form, this connection can be directly with the Remote Computing System 200. However, to overcome firewall traversal problems, the Gateway 900 server may be used as a forwarding gateway. In this manner, the remote access occurs through an intermediary server.

Finally, the Remote Computing System 200 accepts the remote access connection, as depicted in Step 2030. A remote desktop, such as Microsoft's Remote Desktop and VNC's client, is one example of a remote access connection that may be established using this process.

In another embodiment, business logic can determine which Programmatic Procedure 650 to initiate when a Remote Computing System 200 establishes a connection. Communication is established in a similar manner for the Programmatic Procedures 650 as it is when a technical Expert 602 is involved. Instead of manual delivery of support services by an Expert 602 using a remote desktop (or similar) client, a set of commands are issued programmatically through a data connection, such as a SSH connection. Programmatic Procedures 650 could be in the form of scripts that perform automated analysis, recovery or repair actions on the Remote Computing System 200 or an attached Physical Device 100, and are further described in a later section.

### Interfacing Between Client Applications and Program Code

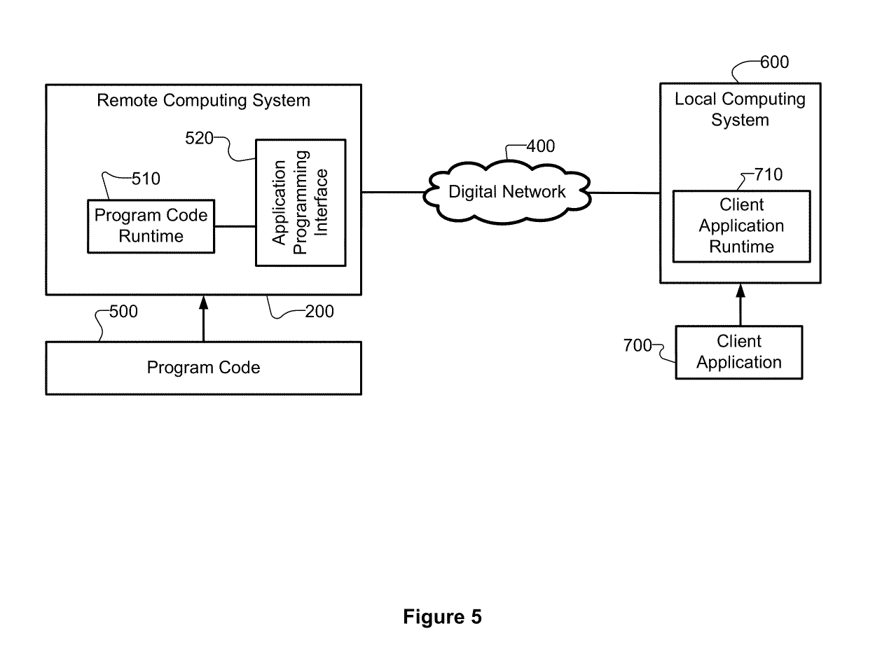

FIGS. 5 through 7 depict an interface between a Client Application 700 and Program Code 500. This interface is an alternative remote access method to the remote desktop approach described above. In this alternative method, a User Interface 610 provides control of, and reporting from, Program Code 500 that is used to control a remote device such as a Non-volatile Storage Device 110, as illustrated in FIG. 7.

In FIG. 5, the interface between the Client Application 700 and the Program Code 500 is achieved through an Application Programming Interface 520 that is executed as part of the Program Code Runtime 510. A corresponding Client Application Runtime 710 establishes a command and data communication channel between the Local Computing System 600 and the Remote Computing System 200 over a Digital Network 400 that may use the Application Programming Interface 520.

In FIG. 6, a similar command and data communication channel is established using a Queue Server 800. The Program Code Runtime 510 establishes a Message Queue Client 530 that retrieves messages from, and submits messages to, the Queue Server 800. A corresponding Message Queue Client 730 is established by the Client Application Runtime 710.

The Intermediary System 1000 shown in FIG. 1 may be used to maintain the interface and provide support services such as authentication, accounting and security. The Web Applications 1100 running on the Intermediary System 1000 may themselves participate in the interface between the Client Application 700 and the Program Code 500, either through an Application Programming Interface or Message Queue approach described above.

### Programmatic Procedures for Automated Analysis, Recovery or Repair

Programmatic Procedures 650 operating on a Local Computing System 600, as depicted in FIG. 1, can substitute or augment the manual procedures of a technical Expert 602.

Programmatic Procedures 650 can be in the form of scripts, such as Bash, Perl, Python or Ruby, that execute on the Local Computing System 600 and issue native operating system commands to the Remote Computing System 200.

Programmatic Procedures 650 can also include domain specific languages that define a system's configurations. Examples of such languages and approaches are Puppet, Chef, BladeLogic™, Opsware and the like. In such a scenario, the Local Computing System 600 runs the engine that employs the domain specific language to determine how the Remote Computing System 200 will be configured.

As an example, upon establishing a Communication Link 405, an Intermediary System 1000 can trigger execution of a Programmatic Procedure 650 to analyze the Remote Computing System 200 and all attached Physical Devices 100. This information may include motherboard details, hard disk model and serial numbers, amount of installed memory, network details, and the like. This information can be presented to the Expert 602 for use in manual delivery of technical services. This information can also be incorporated by other Programmatic Procedures 650. For example, automated recovery procedures may need to know the installed file system type (e.g. Windows, Linux or other) in order to identify the most-suitable recovery applications to use.

### Accessing Physical Devices Remotely

Access to a Physical Device 100 may be obtained by suitably programming the Remote Computing System's 200 hardware using, in part, the Independent Operating System 300 and, in part, some lower level software, such as driver software, that comes supplied with the Program Code 500. This lower level software may be designed for a particular type of Physical Device 100, such as a SCSI hard disk controller driver, camera driver, and so on. The Program Code 500 may provide the suitable drivers, emulation, virtualization, and interfacing software to provide low-level control of, and access to, the Physical Device 100 such as the ability to access and control registers, ports, clocks, and different types of controllers.

FIG. 7 illustrates one approach to access a remote physical device 100 using the interfacing methods described above. In this example, the Non-volatile Storage Device 110 attached to the Remote Computing System 200 is mounted to the Local Computing System 600 using iSCSI technology. This mounting process makes the Non-volatile Storage Device 110 appear as if it were physically attached to the Local Computing System 600 so that analysis, repair and recovery utilities installed on the Local Computing System 600 can be used directly on this mounted, remote storage device. This mounting is shown as Steps 2040 and 6030 in FIG. 9.

With reference to FIGS. 7 and 9, to implement the approach in this embodiment:

(a) Storage controller Device Driver 305 establishes low-level access to the Non-volatile Storage Device 110. This Device Driver 305 is typically activated by the Independent Operating System 300 during the initialization of the Remote Computing System 200 in Step 2010.

(b) iSCSI Target 540 software, activated by the Program Code 500, provides an interface to the Non-volatile Storage Device 110.

(c) iSCSI Initiator 760 software, run by the Client Application 700, interfaces with the iSCSI Target 540 software and provides low-level read and write access to a Non-volatile Storage Device 110 on the Local Computing System 600. This is depicted as step 2040 and 6030.

Using a similar approach, a different Device Driver 305 and Program Code 500 can provide remote access to other types of devices and components attached to the Remote Computing System 200. Similar to the iSCSI example above, these different devices and components would be virtually attached to the Local Computing System 600. With reference to FIG. 8, these other devices and components may include: Volatile Storage 115, Non-Volatile Storage Device 110, Physical Network Interface Device 120, Memory Controller 225, I/O Controller 228 and registers and I/O ports of the CPU 230.

As those skilled in the art will recognize, Device Drivers 305 are provided for many Physical Devices 100 and components of the Main Circuit Board 220. Likewise, special purpose utility programs providing low-level control of peripherals and components exists, such as iSCSI Target 540 code. The section below describes how to combine these drivers and specialized utility programs to enable remote access to a broader range of devices and components. These drivers and programs may be incorporated into the Independent Operating System 300 or Program Code 500.

### Creating Virtual Machines for Indirectly Accessing Remote Physical Devices and Components

It is often necessary to run special purpose, software utility programs directly on a Remote Computing System 200 when providing analysis, recovery, or repair technical support services. Specialized utility programs, such as iSCSI technology described above, are designed to execute directly on the subject Remote Computing System 200. The virtualization technology described below allows remote access to a broader range of devices and components, even in situations when the underlying utility program does not directly support remote access and control. This description further elaborates Steps 2040 and 6030 shown in FIG. 9. With reference to FIGS. 1 and 8, the procedure includes the steps:

(a) Initialize the Remote Computing System 200 with the Independent Operating System 300 where the Program Code 500 includes emulation software, such as Virtualization Software 550, for creating Virtual Machines 555.

(b) Emulate, as part of the Virtualization Software 550, the Physical Devices 100 and components on the Main Circuit Board 220.

(c) Initialize a Virtual Machine 555 with a Virtual Operating System 558 that is required by the software utility program. For example, some low-level utilities operate solely under the Microsoft DOS operating system. In these situations, the Virtual Machine 555 may be configured to run DOS 6.22.

(d) Run the specialized utility program using the Virtual Operating System 558 of the Virtual Machine 555. Scripted or manual procedures may be used to download and install this specialized utility program, if it is not already present on the Virtual Machine 555.

(e) Access and Control the specialized utility program. This may be achieved using a Remote Desktop 740 client that interfaces with a Remote Access Server 560 that is part of the Program Code 500 on the Remote Computing System 200. It may also be achieved using automated scripting tools such as Programmatic Procedures 650.

This approach allows remote control and access of low-level components on the Main Circuit Board 220 using existing, specialized software utilities. This is possible even when these software utilities require operating systems that have no remote access capabilities.

### Virtualizing a Host Computer on Itself and Simulating a Testing Environment

It is often desirable to isolate a computing system and operate it within the confines of a testing environment. For example, a network analyzer that is troubleshooting unusual network activity or suspicious software behavior must have a network connection to the computing system under test. These types of testing environments currently require physical access to the computing system.

The virtualization procedures described below allow these types of advanced analysis techniques to be used remotely. This is achieved by converting the Remote Computing System 200 into a virtualized testing environment and running the system's Installed Operating System 210 as the Virtual Operating System 558.

With reference to FIGS. 8 and 9, and continuing upon the description of the previous subsection, the virtualization is achieved as follows:

(a) The Partition 111 containing the Installed Operating System 210 is mounted as a file system on the Volatile Storage 115.

(b) The Virtual Machine 555 mounts this file system and uses it as the Virtual Operating System 558.

(c) Upon initialization of the Virtual Machine 555, the Installed Operating System 210 is executed within the Virtual Machine 555.

(d) The Remote Desktop 740 access is initiated from the Local Computing System 600 to the Remote Access Server 560 that is operated as part of the Program Code 500 on the Remote Computing System 200.

The Remote Computing System 200 is now operated as a Virtual Machine 555 and can be connected with other Virtual Machines 555 to simulate a testing environment. A network analysis environment will be used as the specific example to illustrate the procedure, as follows:

(e) An additional Virtual Machine 555 is created. Its Virtual Operating Systems 558 is chosen based on the specialized software utility required in the testing environment. For example, the network analysis environment requires a network protocol analyzer, such as software from the open-source SNORT or Wireshark projects. Both of these projects can use a Linux operating system, so the Virtual Machine 555 may be configured to run the Debian distribution of Linux.

(f) The Virtualization Software 550 creates virtual network interfaces on each Virtual Machine 555. The virtualized host-under-test is then network connected to the protocol-analyzer Virtual Machine 555. Data packets from the virtualized host-under-test will now flow through the protocol-analyzer Virtual Machine 555, allowing software such as Wireshark to capture and analyze network traffic.

Remote access to specialized software utilities, such as Wireshark and SNORT in this example, may be achieved through a Network Analysis Client Application 750 that interfaces over a network with the software running on the protocol-analyzer guest.

### Enabling a Joined File System using the Installed Operating System

A Joined File System 116 may be created on the Remote Computing System 200 using either the Independent Operating System 300 or Installed Operating System 210. This permits using the Independent Operating System 300 to be delivered on a read-only Storage Media 310 but still function as a traditional read-and-write operating system. It also simulates writing to the Installed Operating System 210 without actually modifying the data stored on the Installed Operating System 210.

To use the Installed Operating System 210 in a manner that prevents its modification, the Joined File Systems 116 is implemented using the currently preferred method described below and illustrated in FIG. 10. Those skilled in the art will understand that this is one possible embodiment.

(a) The Remote Computing System 200 is initialized with an Independent Operating System 300 and Program Code 500 using a Storage Media 310, as previously described and depicted in FIG. 2.

(b) A Root Directory 119 is created in the Volatile Storage 115 of the Remote Computing System 200. The Volatile Storage 115 is typically random access memory. The Independent Operating System 300 and Program Code 500 execute from this Root Directory 119. The Root Directory 119 can also be created on other storage devices, such as non-volatile hard disk, solid state, or flash drives.

(c) The Partition 111 holding the Installed Operating System 210 and stored on the Non-volatile Storage Device 110 of the Remote Computing System 200 is mounted on the Volatile Storage 115 as a read-only file system. This is depicted as Read-Only Mount 117 in FIG. 10.

(d) A writable file system is created in the Volatile Storage 115. This is depicted as the Writable File System Mount 118 in FIG. 10.

(e) The Writable File System Mount 118 overlays the Read-Only Mount 117 to create the Joined File System 116.

The Joined File System 116 now appears as a single, unified file system where files from the Installed Operating System 210 are available for read-only access and modifications are stored in the overlaid Writable File System Mount 118, not the Installed Operating System 210.

The Joined File System 116 is then used to initialize a Virtual Machine 555. This Virtual Machine 555 executes the Installed Operating System 210 as the Virtual Operating System 558 where all modifications are made only to the Writable File System Mount 118. This improvement allows the Remote Computing System 200 to be used as a remote recovery tool that emulates itself but does not modify data stored on its Non-volatile Storage Device 110.

### Performing Network Analysis Remotely

Using a testing environment created through the procedures described above, network analysis may be performed in the following manner:

(a) An Expert 602 uses the Remote Desktop 740 to access the Virtual Machine 555 that has been used to virtualize the Remote Computing System 200.

(b) The Expert 602 operates the Virtual Machine 555 so as to reproduce a symptom or failure. As a specific example if the Expert 602 suspects the Installed Operating System 210 to be compromised with malware, the Expert 602 may open a web browser, navigate to the website of a well-known financial institution, such as a bank, and attempt to log into an account.

(c) The Network Analysis Program 570, which is operating either on a second Virtual Machine 555 or as part of the Program Code 500 on the host Remote Computing System 200, intercepts network traffic from the Virtual Machine 555. If the Network Analysis Program 570 is operating on a Virtual Machine 555, then the Expert 602 would use a second Remote Desktop 740 client for access and control.

In response to navigating to the website of the example financial institution and attempting to log into an account, the Expert 602 expects to see data packets flowing to servers affiliated with that financial institution. Network traffic flowing to unexpected servers or countries would be a positive indicator for malware infection.

In this manner, an unstable and infected Remote Computing System 200 may be remotely analyzed using a network testing environment that is created on the Remote Computing System 200 itself.

### Recovering Data Remotely

Remote data recovery may be implemented using either the iSCSI or virtualization cases I or II described above. All approaches can be used to provide low-level, read-only data access to Non-volatile Storage Devices 110. Differences between the approaches include: the location where the data recovery software utility will be executed, risk of overwriting data and network bottlenecks.

If the Expert 602 has data recovery software installed on a Local Computing System 600, then remotely mounting a Non-volatile Storage Device 110 is a convenient and effective way to deliver recovery services. However, this approach may not be practical on slow networks as the recovery time would be too great. In addition, this approach cannot be used if it risks modifying data on the Non-volatile Storage Device 110 from which data is to be recovered. For these restricted situations, the virtualization approach is desirable.

In the virtualization approach, a Virtual Machine 555 is used to run the data recovery software utility. The recovery activities occur on the Remote Computing System 200 and only the recovered files are transferred or copied.

### Conducting Digital Forensics Remotely

Digital forensics can be conducted using either the iSCSI or virtualization cases I or II described above. The technical reasons for choosing between these methods are similar to those for data recovery: digital network speed, presence of the necessary software utilities, and prohibitions on modifying data that is to be forensically analyzed.

### Remediating Malware Remotely

Modern malware is effective at evading detection. Such malware uses the compromised operating system itself to determine if a virus scanner is running, or some other means are being used for remediation and becomes dormant to avoid detection. Removing such malware when the compromised operating system is active becomes a frustrating and challenging task.

Malware can be more easily identified and removed when the compromised operating system is not active. This can be achieved using either the iSCSI or virtualization cases I or II described above. The technical reasons for choosing between these methods are similar to those for data recovery: digital network speed and presence of the necessary software utilities.

### Cloning Data Remotely

In a similar manner to data recovery and digital forensics, either iSCSI or virtualization cases I or II described above can be used to clone data from the Non-volatile Storage Device 110 of a Remote Computing System 200 to either a different Remote Computing System 200 or the Local Computing System 600.

### Installing Software Remotely

There are many situations where software fails to install on an existing operating system. The virtualization case II described above allows a technical Expert 602 to perform trial-and-error solutions without adversely affecting the underlying Installed Operating System 210 of the Remote Computing System 200.

For example, incompatible device drivers typically result in system instability. To install these device drivers without rendering the Remote Computing System 200 unstable, a Joined File System 116 is used for (i) installing a device driver, (ii) testing the system by operating various software, and (iii) checking for stability of the operating system. If the device driver is incompatible and the operating system crashes, then the Remote Computing System 200 reboots into its Installed Operating System 210 normally. The trial-and-error procedure then continues using a different device driver until a suitable one is identified.

### Repairing Operating Systems Remotely

Similar to the above method for installing software remotely, the remote repair of an operating system can be achieved by virtualizing the Remote Computing System 200, initializing it in a “safe mode” to minimize the drivers loaded and devices activated and then proceeding with a trail-and-error approach to remove incompatible software or drivers that are causing system instability.

### DETAILED DESCRIPTION

### Alternative Embodiments

As those skilled in the art will recognize, alternative embodiments of the present invention are possible. Some of these are described below.

### Related Patent Application

The system shown in FIG. 1 can be further described by the system in the related patent application Ser. No. 12/200,654. Specifically:

(a) Gateway 900 is a simplification of “Border Controllers”;

(b) Intermediary System 1000 can be expanded to include the entire collection of subsystems shown in FIG. 1 of the related patent application; and,

(c) Independent Operating System 300 is a simplification of “Operating System” and “Boot Disk” discussed in the related patent application.

### Independent Operating System

The Independent Operating System 300 can be any type, including Microsoft DOS or Windows, Linux, Apple Mac OS, Android, and so on. The minimum requirements for the Independent Operating System 300 include (i) means to initialize core hardware such as the CPU and memory controllers, (ii) means to initialize a network interface device, and (iii) means to execute Program Code 500.

### Sequence of Steps

The sequence of steps presented in this application represents the preferred embodiment of the invention. As those skilled in the art will recognize, there are alternative sequences possible that achieve the same result. For example, the Communication Link 405 may be established at various times during the processes described above. These various times can be equally suitable to achieve the same end result.

### Distributed Functionality

As those skilled in the art will recognize, the functionality described above can be implemented through different systems and software. For example with reference to FIG. 8, a network protocol analyzer can be part of the Program Code 500 operating on the Remote Computing System 200. In the description above, the functionality described for the Virtual Machine 555 used to run the protocol-analyzer guest may be entirely incorporated within a Network Analysis Program 570 running outside any Virtual Machine 555.

### CONCLUSION

An embodiment of the invention expands the capabilities of a technical support organization to offer advanced analysis, recovery and repair services to Users 202 remotely. It enables the Expert 602 to obtain low-level control and data access to remote peripherals and components in a manner that preserves the original data on the Remote Computing System 200. It allows automated procedures to perform common tasks and Experts 602 to delivery manual services.

An embodiment of the invention may be a machine-readable medium (such as microelectronic memory) having stored thereon instructions, which program one or more data processing components (generically referred to here as a “processor”) to perform operations for testing the tolerance of a processor in a mobile multi-function communications device under test as described above. In other embodiments, some of these operations might be performed by specific hardware components that contain hardwired logic (e.g., dedicated state machines). Those operations might alternatively be performed by any combination of programmed data processing components and fixed hardwired circuit components.

While the above description and illustrations contain many specifics, these should not be construed as limitations on the scope of the invention, but rather as an exemplification of one preferred embodiment thereof. Accordingly, the scope of the invention should be determined not by the embodiments illustrated, but by the appended claims and their legal equivalents.

What is claimed is:

1. A method for analysis, recovery or repair of a physical device attached to a remote computing system from a local computing system, comprising:
initializing said remote computing system with an independent operating system,
establishing communication between said remote computing system and said local computing system over a digital network,
enabling access to said physical device attached to said remote computing system through program code executing on said remote computing system,
interfacing the local computing system with said program code, and
performing analysis, recovery or repair technical support services on the physical device.

2. The method of claim 1, further comprising: providing a client application operating on the local computing system.

3. The method of claim 1, further comprising: issuing, by programmatic procedures operating on the local computing system, automated analysis, recovery or repair commands to the remote computing system.

4. The method of claim 1, further comprising: recording accounting information such as any one selected from the group consisting of:
funds available,
financial payment details,
time logged,
remaining time available, and
network bandwidth utilized.

5. The method of claim 1, further comprising: creating a virtual machine on said remote computing system.

6. The method of claim 5, further comprising: running on said virtual machine an installed operating system of said remote computing system.

7. The method of claim 5, further comprising: intercepting data packets flowing between said virtual machine and a physical network interface device attached to said remote computing system.

8. The method of claim 1, further comprising: joining together, by a file system:
a new directory structure created in volatile memory of said remote computing system; with,
an existing directory structure accessed in read-only mode on said remote computing system.

9. The method of claim 1, wherein said independent operating system is delivered to said remote computing system through any one selected from the group consisting of:
storage media;
computer server over a digital network;
mobile computing system; and,
online marketplace.

10. The method of claim 1, wherein said enabling access to the physical device includes controlling any one selected from the group consisting of:
input-output registers;
input-output ports;
clocks;
volatile memory controllers;
non-volatile memory controllers; and,
input-output controllers.

11. The method of claim 1, wherein said interfacing the local computing system and the program code is achieved by any one selected from the group consisting of:
an application programming interface provided by said program code; and,
a queue server that exchanges messages over said digital network.

12. The method of claim 1, wherein initializing the remote computing system occurs independently of any non-volatile storage device attached to said remote computing system.

13. The method of claim 1, wherein performing includes any one selected from the group consisting of:
network analysis;
data recovery;
digital forensics;
software installation;
data cloning;
operating system repair; and,
malware remediation.

14. The method of claim 1, further comprising: converting said physical device into a virtual device attached to said local computing system.

15. A remote computing system for analysis, recovery or repair of an attached physical device from a local computing system, comprising:
a hardware processor;
a storage unit that contains:
an independent operating system, which when executed by the hardware processor initializes said remote computing system independently of any native operating system pre-installed on the remote computing system, and
program code that is executed by the hardware processor when the remote computing system has been initialized by the independent operating system to facilitate access to the physical device attached to the remote computing system by the local computing system, and
interfaces for exchanging commands and data between said program code and the local computing system over a digital network,
whereby said initialized remote computing system becomes a remote analysis, recovery or repair tool that may be accessed and controlled from said local computing system to access the physical device attached to the remote computing system.

16. The remote computing system of claim 15, wherein the local computing system executes programmatic procedures to issue commands to said remote computing system.

17. The remote computing system of claim 15, wherein said physical device is a component attached to a main circuit board of said remote computing system.

18. The remote computing system of claim 15, wherein an intermediary system records identifying information and tracks resources such as any one selected from the group consisting of:
funds available,
financial payment details,
time logged,
remaining time available,
activity logging, and
network bandwidth utilized.

19. The remote computing system of claim 15, wherein the initialization of the independent operating system utilizes a mobile computing device connected with said remote computing system.

20. The remote computing system of claim 15, wherein the interfaces include any one selected from the group consisting of:
remote desktop client software,
remote desktop server software,
terminal emulation server software, and,
web application software.

21. The remote computing system of claim 15, further comprising a virtualization component that creates a virtual machine executing the installed operating system of said remote computing system.

22. The remote computing system of claim 21, further comprising a network analysis program intercepting data packets flowing between said virtual machine and a physical network interface device attached to said remote computing system.

23. The remote computing system of claim 15, wherein said physical device becomes a virtual device attached to said local computing system after the program code executes.
